(19) United States
(12) Patent Application Publication
(10) Pub. No.: US 2022/0122760 A1
(43) Pub. Date: Apr. 21, 2022

(54) COIL COMPONENT

(71) Applicant: SAMSUNG ELECTRO-MECHANICS CO., LTD., Suwon-si (KR)

(72) Inventors: Ye Ji Jung, Suwon-si (KR); Jae Hun Kim, Suwon-si (KR)

(21) Appl. No.: 17/135,057

(22) Filed: Dec. 28, 2020

(30) Foreign Application Priority Data
Oct. 16, 2020 (KR) 10-2020-0133988

(51) Int. Cl. H01F 27/29; H01F 17/00; H01F 27/32

(52) U.S. Cl. CPC H01F 27/292; H01F 2017/0073; H01F 27/32; H01F 17/0013

(57) ABSTRACT

A coil component includes: a body having first and second surfaces facing each other, third and fourth surfaces connecting the first and second surfaces and facing each other, and fifth and sixth surfaces connecting the first to fourth surfaces and facing each other; an insulating substrate disposed inside the body; a coil portion disposed on at least one surface of the insulating substrate, connected to a coil portion and an end portion connected to the coil pattern, and including a lead-out portion where one surface is exposed externally of the body; and first and second external electrodes covering the lead-out portion exposed externally of the body. The first external electrode is disposed on at least a portion of each of the first, third, fifth and sixth surfaces, and the second external electrode is disposed on at least a portion of each of the second, third, fifth, and sixth surfaces.

### CROSS-REFERENCE TO RELATED APPLICATION(S)

This application claims the benefit of priority to Korean Patent Application No. 10-2020-0133988, filed on Oct. 16, 2020 in the Korean Intellectual Property Office, the entire disclosure of which is incorporated herein by reference for all purposes.

### TECHNICAL FIELD

The present disclosure relates to a coil component in which an external electrode is formed by a dipping method.

### BACKGROUND

As smartphones evolve, demand for high-current, high-efficiency, and high-performance inductors, as well as miniaturized and thinned inductors, is increasing. Accordingly, as compared to the past, it is expected that products will be miniaturized, with gradually reduced sizes. As the size is reduced, not only the process but also the design needs to be optimized in consideration of chip size.

An inductor is a typical passive electronic component used in electronic devices, in addition to a resistor and a capacitor.

Thereamong, a thin film-type coil component is manufactured by forming a coil on an insulating substrate with a plating method, to manufacture a coil substrate, and then by stacking a magnetic composite sheet obtained by mixing magnetic powder and a resin on the coil substrate to form manufacture a body, and by forming an external electrode on the outside of the body.

However, as a miniaturized coil component is manufactured, a phenomenon in which connection reliability between a lead-out portion and a coil portion is deteriorated may occur due to stress concentration in a portion in which the lead-out portion and the coil portion are connected in the coil component.

### SUMMARY

An aspect of the present disclosure is to provide a coil component having improved connection reliability between a lead-out portion and a coil portion.

Another aspect of the present disclosure is to provide a coil component capable of increasing inductance of the component by increasing the number of turns of the coil pattern of the coil portion.

Another aspect of the present disclosure is to provide a coil component having improved adhesive strength of the coil component by increasing a surface area of the external electrode.

According to an aspect of the present disclosure, a coil component may include: a body having first and second surfaces facing each other in a length direction, third and fourth surfaces connecting the first and second surfaces and facing each other in a thickness direction, and fifth and sixth surfaces connecting the first to fourth surfaces and facing each other in a width direction; an insulating substrate disposed inside the body; a coil portion disposed on at least one surface of the insulating substrate, and including a coil pattern and a lead-out portion connected to an end portion of the coil pattern, wherein the lead-out portion includes one surface is exposed externally of the body; and

first and second external electrodes covering the lead-out portion exposed externally of the body. The first external electrode may be disposed on at least a portion of each of the first, third, fifth and sixth surfaces, and the second external electrode may be disposed on at least a portion of each of the second, third, fifth, and sixth surfaces.

According to another aspect of the present disclosure, a coil component may include: a body; an insulating substrate disposed inside the body; a coil portion disposed on at least one surface of the insulating substrate, and including first and second coil patterns and first and second lead-out portions connected to end portions of the first and second coil patterns, respectively, and exposed externally of the body; and first and second external electrodes respectively covering the first and second lead-out portions and disposed to be spaced apart from each other. The first external electrode may be disposed on at least a portion of a first surface among external surfaces of the body, to which the first lead-out portion is exposed, and further disposed on at least a portion of each of three surfaces respectively connected to the second surface, and the second external electrode may be disposed on at least a portion of a second surface among external surfaces of the body, to which the second lead-out portion is exposed, and further disposed on at least a portion of each of three surfaces respectively connected to the second surface.

According to still another aspect of the present disclosure, a coil component may include: a body; an insulating substrate disposed inside the body; a coil portion disposed on at least one surface of the insulating substrate, and including a coil pattern and first and second lead-out portions connected to first and second end portions of the coil pattern, respectively, and exposed externally of the body; and first and second external electrodes, each having an ‘L’ shape, connected to the first and second lead-out portions, respectively. The first and second external electrodes may be respectively disposed on edge portions of a lower surface of the body, which are opposing each other in a length direction. A winding axis of the coil portion may be substantially parallel to the lower surface of the body. Each of the first and second external electrodes may further extend onto front and rear surfaces of the body, opposing each other in a width direction which is substantially parallel to the winding axis of the coil portion and substantially perpendicular to the length direction.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 is a perspective view schematically illustrating a dispositional structure of a body and an external electrode of a coil component according to the present disclosure;

FIG. 2 is a process diagram schematically illustrating a dipping process for forming an external electrode according to the present disclosure;

FIG. 3 is a perspective view of a coil component according to a first embodiment of the present disclosure;

FIG. 4 is a transmittance view of the coil component of FIG. 3 as viewed in a width direction;

FIG. 5 is a cross-sectional view of the coil component of FIG. 4 taken along line I-I′;

FIG. 6 is a perspective view of a coil component according to a second embodiment of the present disclosure;

FIG. 7 is a transmittance view of the coil component of FIG. 6 viewed in a width direction;

FIG. 8 is a cross-sectional view of the coil component of FIG. 7 taken along II-II′;

FIG. 9 is a perspective view of a coil component according to a third embodiment of the present disclosure;

FIG. 10 is a transmittance view of the coil component of FIG. 9 as viewed in the width direction; and

FIG. 11 is a cross-sectional view of the coil component of FIG. 10 taken along

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to, ” or “coupled to” the other element, or there may be one or more other elements intervening therebetween. In contrast, when an element is described as being “directly on,” “directly connected to,” or “directly coupled to” another element, there may be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” maybe used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after gaining an understanding of the disclosure of this application. Further, although the examples described herein have a variety of configurations, other configurations are possible as will be apparent after gaining an understanding of the disclosure of this application.

The drawings may not be to scale, and the relative size, proportions, and depiction of elements in the drawings may be exaggerated for clarity, illustration, and convenience.

In the drawings, an L direction may be defined as a first direction or a length direction, a W direction may be defined as a second direction or a width direction, and a T direction may be defined as a third direction or a thickness direction.

Hereinafter, a coil component according to an embodiment of the present disclosure will be described in detail with reference to the accompanying drawings, and in the description with reference to the accompanying drawings, the same or corresponding components are given the same reference numbers, and overlapping descriptions thereof will be omitted.

Various types of electronic components are used in electronic devices, and various types of coil components may be appropriately used between the electronic components for the purpose of removing noise. In other words, in electronic devices, coil components may be used as power inductors, high-frequency (HF) inductors, general beads, high-frequency beads (GHz beads), common mode filters, and the like.

Meanwhile, hereinafter, it will be described on the premise that coil components 1000, 2000, and 3000 according to an embodiment of the present disclosure are thin film-type inductors used for a power line of a power supply circuit. However, the coil component according to the embodiment of the present disclosure may be appropriately applied as a chip bead, a chip filter, or the like, in addition to the thin film-type inductor.

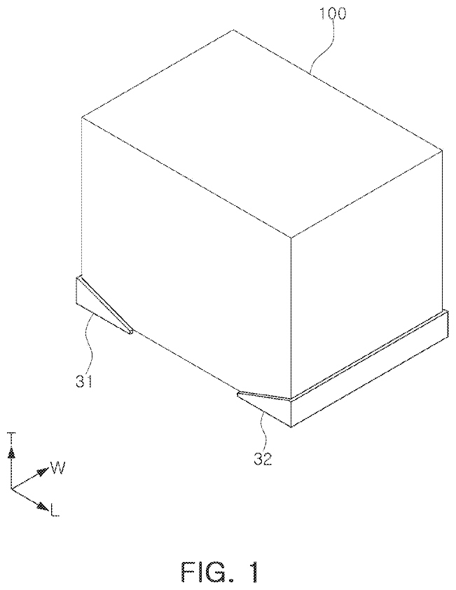

FIG. 1 is a perspective view schematically illustrating a dispositional structure of a body and an external electrode of a coil component according to the present disclosure.

The coil component 1000, 2000, and 3000 according to the present disclosure includes a body 100 having a first surface 101 and a second surface 102 facing each other, a third surface 103 and a fourth surface 104 connecting the first and second surfaces 101 and 102 and facing each other, and a fifth surface 105 and a sixth surface 106 connecting the first to fourth surfaces 101, 102, 103, and 104 and facing each other. The first and second surfaces 101 and 102 may refer to first and second side surfaces of the body 100, and the third surface 103 may refer to a lower surface of the body 100. The fifth and sixth surfaces 105 and 106 may refer to front and rear surfaces of the body 100.

First and second external electrodes 31 and 32 may be respectively disposed on at least a portion of external surfaces of the body 100, and the first external electrode 31 may be disposed on at least a portion of each of the first surface 101, the third surface 103, the fifth surface 105, and the sixth surface 106, and the second external electrode 32 may be disposed on at least a portion of each of the second surface 102, the third surface 103, the fifth surface 105, and the sixth surface 106.

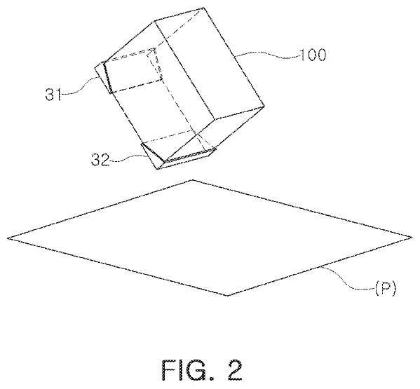

FIG. 2 is a process diagram schematically illustrating a dipping process for forming an external electrode according to the present disclosure.

Here, the dipping method refers to a method forming an external electrode 30 by applying a paste to an exterior of the body 100 using viscosity and surface tension of a metal paste P through a process of dipping the body 100 of the coil component on a surface plate coated with a metal paste of a certain thickness. The metal paste P may be a conductive resin in which metal particles in an insulating resin are dispersed.

After forming the first and second external electrodes 31 and 32 through a dipping process, the first and second external electrodes 31 and 32 may be cured through a curing process, and as a result, the first and second external electrodes 31 and 32 may include a paste composed of a resin in which metal having excellent electrical conductivity is dispersed, for example, may include a conductive resin including metal such as nickel (Ni), copper (Cu), tin (Sn), silver (Ag), or an alloy thereof. Formation and dispositional structure of the external electrode by the dipping method will be described in more detail in the following description of the formation of the external electrode 30.

### First Embodiment

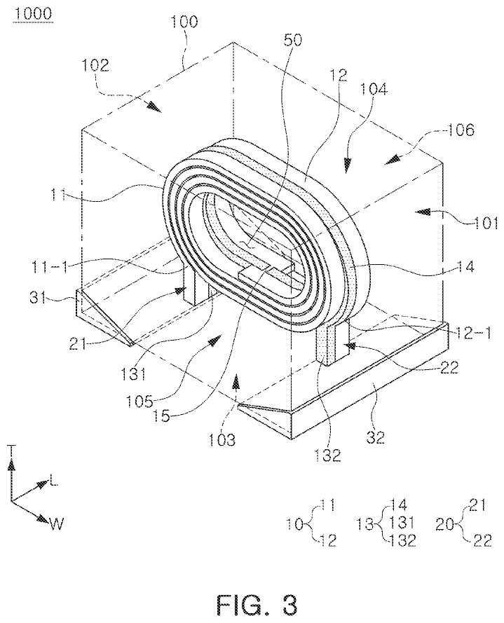

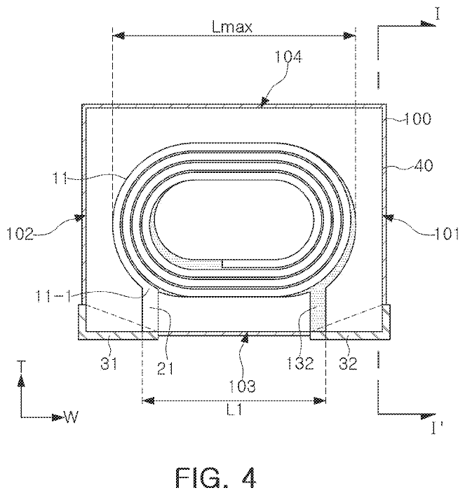

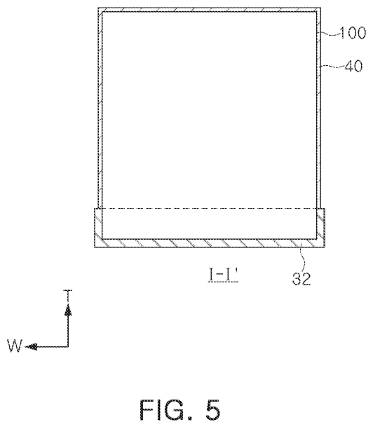

FIG. 3 is a perspective view of a coil component according to a first embodiment of the present disclosure. FIG. 4 is a transmittance view of the coil component of FIG. 3 as viewed in a width direction. FIG. 5 is a cross-sectional view of the coil component of FIG. 4 taken along line I-I′.

Referring to FIG. 3, a coil component 1000 according to an embodiment of the present disclosure may include a body 10, an insulating substrate 13, a coil portion 10, a lead-out portion 20, and an external electrode 30.

The body 100 forms an overall appearance of the coil component 1000, and the insulating substrate 13 is disposed inside the body 100.

The body 100 may be formed in a hexahedral shape overall.

Based on FIG. 1, the body 100 includes a first surface 101 facing each other in a length direction L, a third surface 103 and a fourth surface 104 facing each other in a thickness direction T, and a fifth surface 105 and a sixth surface 106 facing each other in a width direction W. Each of the third surface 103 and the fourth surface 104 of the body 100 facing each other connects the first surface 101 and the second surface 102 of the body 100 facing each other.

The body 100 may be formed such that the coil component 1000 according to the present embodiment, having an external electrode 30 formed thereon, to be described later, has a length of 0.2±0.1 mm, a width of 0.25±0.1 mm, and a thickness of 0.4 mm, but an embodiment thereof is not limited thereto.

The body 100 may include magnetic powder and an insulating resin. Specifically, the body 100 may be formed by stacking one or more magnetic composite sheets including an insulating resin and magnetic powder dispersed in the insulating resin. However, the body 100 may have a structure other than a structure in which magnetic powder is dispersed in an insulating resin. For example, the body 100 may be formed of a magnetic material such as ferrite.

The magnetic powder may be, for example, ferrite powder or metal magnetic powder.

The ferrite power may be one or more of spinel ferrite such as Mg—Zn based ferrite, Mn—Zn based ferrite, Mn—Mg based ferrite, Cu—Zn based ferrite, Mg—Mn—Sr based ferrite, Ni—Zn based ferrite, and the like, hexagonal ferrite such as Ba—Zn based ferrite, Ba—Mg based ferrite, Ba—Ni based ferrite, Ba—Co based ferrite, Ba—Ni—Co based ferrite, and the like, garnet ferrite such as Y based ferrite, and Li based ferrite, for example.

The magnetic metal powder may include one or more of iron (Fe), silicon (Si), chromium (Cr), cobalt (Co), molybdenum (Mo), aluminum (Al), niobium (Nb), copper (Cu), and nickel (Ni), and an alloy thereof. For example, the magnetic metal powder may be powder including one or more materials among pure iron powder, Fe—Si based alloy powder, Fe—Si—Al based alloy powder, Fe—Ni based alloy powder, Fe—Ni—Mo based alloy powder, Fe—Ni—Mo—Cu based alloy powder, Fe—Co based alloy powder, Fe—Ni—Co based alloy powder, Fe—Cr based alloy powder, Fe—Cr—Si based alloy powder, Fe—Si—Cu—Nb based alloy powder, Fe—Ni—Cr based alloy powder, and Fe—Cr—Al based alloy powder.

The magnetic metal powder may be amorphous or crystalline. For example, the magnetic metal powder may be Fe—Si—Bp—Cr based amorphous alloy powder, but an example thereof is not limited thereto.

The ferrite and the magnetic metal powder may have an average particle diameter of 0.1 μm to 30 μm, respectively, but an example of the average diameter is not limited thereto.

The body 100 may include two or more types of magnetic materials dispersed in an insulating resin. Here, the magnetic materials have different types, meaning that the magnetic materials dispersed in the insulating resin are distinguishable from each other by any one of an average diameter, a composition, crystallinity, and a shape.

The resin may include one of epoxy, polyimide, liquid crystal polymer, or a mixture thereof, but an example of the resin is not limited thereto.

The insulating substrate 13 is disposed inside the body 100, and the coil portion 10 includes first and second coil patterns 11 and 12, and the first and second coil patterns 11 and 12 are disposed on both sides of the insulating substrate 13, respectively. The insulating substrate 13 includes a support portion 14 supporting the first and second coil patterns 11 and 12 and end portions 131 and 132 supporting the lead-out portion 20 to be described later.

The insulating substrate 13 may be formed of a thermosetting insulating resin such as an epoxy resin, a thermoplastic insulating resin such as a polyimide, or a photosensitive insulating resin, or a material in which a reinforcing material such as a glass fiber or an inorganic filler is impregnated with these resins, or the like. For example, the insulating substrate 13 may be formed of an insulating material such as prepreg, Ajinomoto Build-up Film (ABF), FR-4, a bismaleimide triazine (BT) resin, a photoimageable dielectric (PID) film, and the like, but is not limited thereto.

As the inorganic filler, one or more selected from the group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃).

When the insulating substrate 13 is formed of an insulating material of an insulating material including a reinforcing material, the insulating substrate 13 may provide relatively superior rigidity. When the insulating substrate 13 is formed of an insulating material that does not contain glass fiber, the insulating substrate 13 may reduce the thickness of the overall coil portion 10.

The support portion 14 is a region of the insulating substrate 13, which is disposed between the first and second coil patterns 11 and 12 to support the coil portion 10. The first end portion 131 extends from the support portion 14 to support the first lead-out portion 21. The second end portion 132 extends from the support portion 14 to support the second lead-out portion 22.

The coil portion 10 is disposed on both surfaces of the insulating substrate 13 facing each other, to exhibit characteristics of the coil component. For example, when the coil component 10 of the present embodiment is used as a power inductor, the coil portion 10 stores an electric field as a magnetic field and maintains an output voltage, thereby stabilizing the power of an electronic device.

According to an embodiment of the present disclosure, the coil portion 10 may be formed to be upright with respect to the third surface 103 or the fourth surface 104 of the body 100.

The coil portion 10 is formed to be upright with respect to the third surface 103 or the fourth surface 104 of the body 100, which means that a surface of the coil portion 10 is in contact with the insulating substrate 13, is formed to be perpendicular or close to be perpendicular to the third surface 103 or the fourth surface 104 of the body 100. For example, the coil portion 10 and the third surface 103 or the fourth surface 104 of the body 100 may be formed to be upright at 80° to 100°.

Meanwhile, the coil portion 10 may be formed to be parallel to the fifth surface 105 and the sixth surface 106 of the body 100. That is, the surface of the coil unit 10 in contact with the insulating substrate 13 may be parallel to the fifth surface 105 and the sixth surface 106 of the body 100.

The coil portion 10 may include first and second coil patterns 11 and 12, and each of the first and second coil patterns 11 and 12 may include one or more conductive layers.

The first and second coil patterns 11 and 12 may be formed of a conductive material such as copper (Cu), aluminum (Al), silver (Ag), tin (Sn), gold (Au), nickel (Ni), lead (Pb), titanium (Ti), or alloys thereof, but the embodiment is not limited thereto.

As the body 100 is miniaturized to a size of 1608 or 1006 or less, since a body 100 having a thickness greater than the width is formed, and a cross-sectional area of the cross-section of the body 100 in an L-T direction becomes greater than a cross-sectional area of the cross-section of the body 100 in an L-W direction, as the coil portion 10 is formed to be upright with respect to the third surface 103 or the fourth surface 104 of the body 100, an area in which the coil portion 10 may be formed increases.

For example, when the length of the body 100 is 1.6±0.2 mm and the width is 0.8±0.05 mm, the thickness may satisfy a range of 1.0±0.05 mm (size 1608), and when the length of the body 100 is 0.2±0.1 mm and the width is 0.25±0.1 mm, the thickness may satisfy a range of a maximum of 0.4 mm (1006 size). But, since the thickness is greater than the width, a wider area may be secured when the coil portion 10 is formed vertically, compared when the coil portion 10 is formed horizontally with respect to the third surface 103 or the fourth surface 104 of the body 100. As the area in which the coil portion 10 is formed increases, inductance L and a quality factor Q may be improved.

The first coil pattern 11 disposed on one surface of the insulating substrate 13 may face each other with the second coil pattern 12 disposed on the other surface of the insulating substrate 13, and may be electrically connected to each other through a via 15 located on the insulating substrate 13.

Each of the first coil pattern 11 and the second coil pattern 12 may have a planar spiral shape in which at least one turn is formed about a core portion 50. For example, the first and second coil patterns 11 and 12 may form at least one turn about the core portion 50 on one surface and the other surface of the insulating substrate 13, respectively.

The lead-out portion 20 may include first and second lead-out portions 21 and 22, and the first and second lead-out portions 21 and 22 may be connected to first and second coil patterns 11 and 12, respectively. Specifically, one end of each of the first and second lead-out portions may be connected to end portions 11-1 and 11-2 of the first and second coil patterns, and the other end of each of the first and second lead-out portions 21 and 22 may be exposed to the outside of the body 100.

In the case of FIG. 3, a structure, in which the lead-out portion 20 extends from the first and second coil patterns 11 and 12 and is disposed inside the body 100, and maintains the extended shape as it is, and is exposed to the external surface of the body 100, is illustrated.

However, it is not limited to the illustrated structure, and the lead-out portion 20 may also have an L-shape in a region of the body 100 that is exposed to the external surface of the body 100. According to the this structure, the first and second lead-out portions 21 and 22 according to the present disclosure may be disposed narrower than the width of the body 100, and the first and second lead-out portions 21 and 22 may extend from the third surface 103 of the body 100 to be led out to the first surface 101 and the second surface 102, respectively.

Inductor performance such as inductance L and a quality factor Q may be improved by reducing an influence of the lead-out portion 20, interfering with a flow of magnetic flux as the lead-out portion 20 is formed on the third surface 103 of the body 100. The lead-out portion 20 may include conductive metal such as copper (Cu), and is integrally formed when the coil portion 10 is plated.

End portions 11-1 and 12-1 of the first and second coil patterns mean remaining end portions except for the end portion connected to the via 15 among one end portion and the other end portion of each of the first and second coil patterns 11 and 12. According to an embodiment of the present disclosure, the coil portion and the lead-out portion 20 may be integrally formed. Specifically, the first coil pattern 11 and the first lead-out portion 21 may be connected at the end portion 11-1 of the first coil pattern to be integrally formed with each other, and the second coil pattern 12 and the second lead-out portion 22 may be connected at the end portion 12-1 of the second coil pattern to be integrally formed with each other. In the plating process, a plating resist for forming the coil portion 10 and the lead-out portion 20 may be integrally formed so that the lead-out portion 20 may also be plated when the coil portion 10 is plated.

In the case of the coil components 1000, 2000, and 3000 according to the present disclosure, the end portions 11-1 and 12-1 of the first and second coil patterns may be located below the central portion of the body 100 in the thickness direction. In other words, the end portions 11-1 and 12-1 of the first and second coil patterns maybe located below a height corresponding to 50% of the height of the body 100 in the thickness direction T. Through such a structure, each of the end portions 11-1 and 12-1 of the first and second coil patterns may increase the number of turns by a maximum of ¼ turn, and as a result, the coil portion 10 has an effect of increasing the number of turns by a maximum of ½ turn. Since the inductance L of the coil component increases in proportion to the number of turns of the coil, in the case of the coil component according to the present disclosure, the inductance L can be improved by increasing the number of turns of the coil portion 10.

In addition, as can be seen from the perspective view of FIG. 3, first and second external electrodes 31 and 32 may be disposed on an external surfaces of the coil component 1000. In the case of the coil component 1000 according to the present disclosure, the external electrode 30 may be applied primarily by dipping the body 100 into a metal paste P, and it is possible to simplify the external electrode coating process and improve productivity through the dipping process.

In addition, in the case of the coil components 1000, 2000, and 3000 according to the present disclosure, unlike a method of applying an external electrode through a conventional dipping method, a dipping process may be performed while the body 100 is tilted at a predetermined angle. Thereby, by performing a single dipping process, the external electrode 30 can be applied to a necessary region among four surfaces of the body, so it is advantageous to form the external electrode 30 only in a partial region of the external surface of the body 100.

That is, the first external electrode 31 may be disposed on an external surface of the body 100 to which the first lead-out portion 21 is exposed and on at least a portion of each of three surfaces respectively connected to the surface to which the first lead-out portion 21 is exposed, and the second external electrode 32 may be disposed on an external surface of the body 100 to which the second lead-out portion 22 is exposed and on at least a portion of each of three surfaces respectively connected to the surface to which the second lead-out portion 22 is exposed. This is a dispositional structure that can be applied to all of the coil components 1000, 2000, and 3000 according to the present disclosure, regardless of the embodiment.

Referring to the coil component 1000 according to the first embodiment shown in FIG. 3, each of the first and second external electrodes 31 and 32 may be applied through the above-described dipping process. Thus, the first external electrode 31 may be disposed not only on the first surface 101 and the third surface 103, but also on at least a portion of the fifth surface 105 and the sixth surface 106 facing in the width direction W. Similarly, the second external electrode 32 maybe disposed not only on the second surface 102 and the third surface 103, but also on at least a portion of the fifth and sixth surfaces 105 and 106.

The coil components 1000, 2000, and 3000 according to the present disclosure may all have a structure of an external electrode 30 disposed on the fifth and sixth surfaces facing in the width direction W, such that it is possible to form a wide surface area structure of the external electrode 30, and accordingly, when the coil component is connected to other components using the external electrode 30, high adhesive strength with the other components connected to the external electrode 30 may be implemented.

An insulating layer 40 may be disposed on the external surface of the body 100 on which the external electrode 30 is not formed, after the first and second external electrodes 31 and 32 are formed, but the insulating layer 40 does not have to be disposed.

FIG. 4 is a cross-sectional view of the coil component of FIG. 3 taken along line I-I′, and FIG. 5 is a cross-sectional view of the coil component of FIG. 4 taken along line II-II′.

In the coil component 1000 according to the first embodiment, the coil portion 10 includes first and second lead-out portions 21 and 22, respectively, and as described above, the first and second lead-out portions 21 and 22 are connected to end portions 11-1 and 12-1 of each of first and second coils. The other end portion of the end portions of the first and second lead-out portions 21 and 22 that are not connected to the end portions 11-1 and 12-1 of each of the first and second coils may be exposed externally of the body 100.

Referring to FIG. 4, in the case of the coil component 1000 according to the first embodiment, one end of the first coil pattern 11 formed on one surface of the insulating substrate 13 extends to form a first lead-out portion, and the first lead-out portion may be exposed to the third surface 103 of the body 100. In addition, one end of the second coil pattern 12 formed on the other surface of the insulating substrate 13, facing the one surface of the insulating substrate 13, extends to form a second lead-out portion 22, and the second lead-out portion may also be exposed to the third surface 103 of the body 100. The exposed first and second lead-out portions 21 and 22 maybe connected to first and second external electrodes 31 and 32, respectively.

In the case of the present disclosure, since a structure of a thin-film type coil portion disposed vertically is disclosed, and as described above, the first and second lead-out portions 21 and 22 can be easily exposed and connected to an external electrode 30.

Referring to FIGS. 3 and 4, the external electrode 30 and the coil portion 10 are connected to each other through the lead-out portion 20 disposed in the body 100. Since the body 100 includes an insulating resin and a metal magnetic material and the external electrode 30 includes conductive metal, there is a strong tendency not to be mixed because they are made of different materials. Accordingly, by forming the lead-out portion 20 inside the body 100 and exposing the same to the outside of the body 100, the external electrode 30 and the lead portion 20 can be connected to each other.

At least one of the coil portion 10, the via 15, and the lead-portion 20 may include one or more conductive layers.

For example, when the coil portion 10, the lead-out portion 20, and the via 30 are formed on both surfaces of the insulating substrate 13 by plating, each of the coil portion 10, the lead-out portion 20, and the via 15 may include a seed layer such as an electroless plating layer, and an electroplating layer. Here, the electroplating layer may have a single layer structure or a multilayer structure. The electroplating layer of a multilayer structure may be formed in a conformal film structure in which one plating layer is covered by the other plating layer, or may be formed to have a shape in which the other plating layer is laminated only on one surface of one plating layer. The seed layer of the coil portion 10, the seed layer of the lead-out portion 20, and the seed layer of the via 15 may be integrally formed such that a boundary therebetween may not be formed, but an embodiment thereof is not limited thereto. The electroplating layer of the coil portion 10, the electroplating layer of the lead-out portion 20, and the electroplating layer of the via 15 may be integrally formed such that a boundary therebetween may not be formed, but an embodiment thereof is not limited thereto.

Each of the coil portion 10, the lead-out portion 20, and the via 15 may be formed of a conductive material such as copper (Cu), aluminum (Al), silver (Ag), gold (Au), lead (Pb), titanium (Ti), or an alloy thereof, but an embodiment is not limited thereto.

With respect to the external electrode 30 according to the present disclosure, the external electrode 30 may include first and second external electrodes 31 and 32, and the first external electrode 31 maybe respectively disposed on the first, third, fifth and sixth surfaces of the body 100, and the second external electrode 32 maybe respectively disposed on the second, third, fifth, and sixth surfaces of the body 100.

On the third surface, each of the first and second external electrodes 31 and 32 may be disposed to be narrower than the width of the body 100. The first external electrode 31 may have a structure of covering the first lead-out portion 21 and extending from the third surface 103 of the body 100 to be disposed on the first surface 101, the fifth surface 105, and the sixth surface 106 of the body 100, and the second external electrode 32 may have a structure of covering the second lead-out portion 22 and extending from the third surface 103 of the body 100 to be disposed on the second surface 102, the fifth surface 105, and the sixth surface 106 of the body 100. As described above, since the first and second external electrodes 31 and 32 are also be disposed on the fifth and sixth surface facing in the width direction W, as compared to a conventional external electrode structure that is not disposed on the external surface of the body in the width direction W, since the surface area thereof is wide, it is possible to improve reliability during signal transmission, and simultaneously, a contact area between the body 100 and the external electrode 30 is increased, thereby improving the adhesion strength in the contact area between the body 100 and external electrode 30. In addition, since the external electrode 30 is also disposed in the width direction, and the surface area of the external electrode 30 increases, and when the coil component 1000 is disposed on a substrate (not shown) to be described later, the adhesive strength between the substrate and the coil component 1000 may also be improved. This corresponds to a structure, derived by forming the first and second external electrodes 31 and 32, and specifically dipping the body 100 in a state inclined with respect to the surface of the metal paste P.

In addition, in the coil component 1000 according to the present disclosure, a length of each of the first and second external electrodes 31 and 32 may be 30% or less of the length of the body 100 based on the length direction L, but an embodiment is not limited thereto. In addition, a height of each of the first and second external electrodes 31 and 32 may be 10% or less of the thickness of the body 100 based on the thickness direction T, but an embodiment is not limited thereto. By having the length and height of the first and second external electrodes 31 and 32, it is prevented from being disconnected due to structural instability between the coil portion 10 and the lead-out portion 20, thereby improving connection reliability of the coil components.

The external electrode 30 may be formed in a single layer or multiple layers structure. Each of the first and second external electrodes 31 and 32 may include a first layer 30a covering the lead-out portion 20 and a second layer 30b covering the first layer 30a. In this case, the first layer 30a may include silver (Ag), and the second layer 30b may include at least one of nickel (Ni) and tin (Sn). Specifically, the first external electrode 31 may include a first layer 31a and a second layer 30b covering the first layer 31a, and the second external electrode 32 is a first layer 31b and a second layer 32b covering the first layer 31a.

Regarding the formation of the external electrode 30 by the dipping method, in the case of the coil component according to the present disclosure, the first layers 31a and 32a of each of the first and second external electrodes 31 and 32 may be formed on at least portions of external surfaces of the body 100 by dipping process of the metal paste P. Thereafter, second layers 31b and 32b covering the first layers 31a and 32a may be disposed on the first layers 31a and 32a.

After forming the first layers 31a and 32a of each of the first and second external electrodes 31 and 32 through a dipping process, the first layers 31a and 32a may be cured through a curing process, and as a result, the first layers 31a and 32a may include a paste composed of a resin in which metal having excellent electrical conductivity is dispersed, and may include a conductive resin including, for example, nickel (Ni), copper (Cu), tin (Sn) or silver (Ag), or an alloy thereof. In particular, the first layers 31a and 32a may include a conductive resin including silver (Ag) in the epoxy resin. After the curing process of the first layers 31a and 32a, second layers 31b and 32b covering the first layers 31a and 32a may be formed, and the second layers 31b and 32b may include metal such as nickel (Ni), copper (Cu), tin (Sn), silver (Au), or the like, or an alloy thereof, and in particular, may include at least one of nickel (Ni) or tin (Sn).

### Second Embodiment

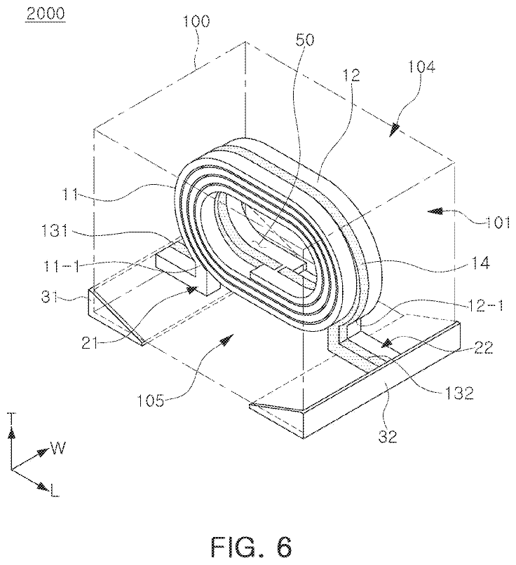

FIG. 6 is a perspective view of a coil component according to a second embodiment of the present disclosure.

Referring to FIG. 6, compared with the coil component 1000 according to the first embodiment of the present disclosure, a coil component 20000 according to a second embodiment has a different shape and an exposure position of the lead-out portion 20. Therefore, in describing the present embodiment, only the shape and exposure position of the lead-out portion 20, different from those of the first embodiment will be described.

For the rest of the configuration of the present embodiment, the description in the first embodiment of the present disclosure may be applied as it is.

In the case of the coil component 2000 according to the second embodiment of the present disclosure, the first and second lead-out portions 21 and 22 may be exposed to the side portion of the body 100. Specifically, the first and second lead-out portions 21 and 22 may be exposed to the first surface 101 and the second surface 102 of the body, respectively.

In the case of the coil component 2000 according to the second embodiment, as in the first embodiment 1000, end portions 11-1 and 12-1 of the first and second coil patterns may be located below a central portion of the body 100 in the thickness direction T. In other words, the end portions 11-1 and 12-1 of the first and second coil patterns may be located below a height, corresponding to 50% of a height of the body 100 in the thickness direction. Through such a structure, each of the first and second coil patterns 11 and 12 may increase the number of turns by a maximum of ¼ turn, and as a result, the coil portion 10 may have an effect of increasing the number of turns by a maximum of ½ turn. Since inductance L of the coil component increases in proportion to the number of turns of the coil, in the case of the coil component according to the present disclosure, the inductance L may be improved by increasing the number of turns of the coil portion 10.

The first and second lead-out portions 21 and 22 may extend from the end portions 11-1 and 12-1 of the first and second coil patterns, respectively, and may be exposed to the side surface of the body 100. Specifically, in the case of the second embodiment, one end portion of the first lead-out portion 21 is connected to the end portion 11-1 of the first coil pattern, and the other end portion is exposed to the first surface 101 of the body. Similarly, one end portion of the second lead-out portion 22 is connected to the end portion 12-1 of the second coil pattern, and is exposed to the second surface 102 of the body.

According to this embodiment, the first and second lead-out portions 21 and 22 may extend downwardly towards the third surface 103 of the body 100, and may be bent to extend laterally towards the second surface 102 and the first surface 101 of the body 100, respectively.

Similarly to the first embodiment, the first external electrode 31 may be disposed on a surface among external surfaces of the body 100 on which the first lead-out portion 21 is exposed, and on at least a portion of each of three surfaces respectively connected to the surface on which the first lead-out portion 21 is exposed, and the second external electrode 32 maybe disposed on a surface among external surface of the body on which the second lead-out portion 22 is exposed, and on at least a portion of each of three surfaces respectively connected to the surface on which the second lead-out portion 22 is exposed.

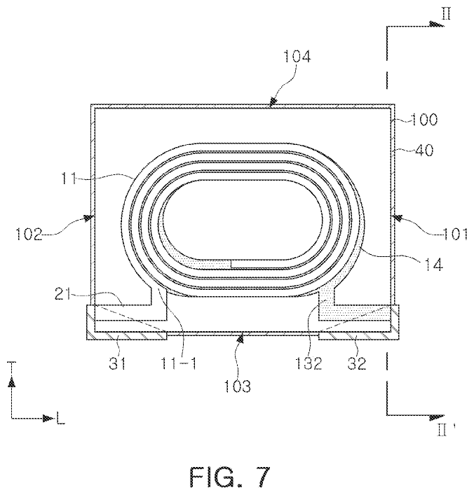

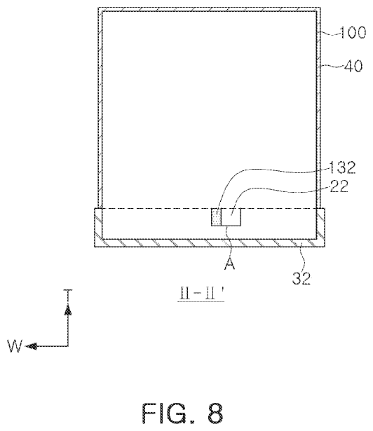

FIG. 7 is a transmittance view of the coil component of FIG. 6 viewed in a width direction, and FIG. 8 is a cross-sectional view of the coil component of FIG. 7 taken along line II-II′.

FIG. 7 shows a structure of the coil component 2000 including the first and second lead-out portions 21 and 22 exposed to the side surface of the body 100, as described above, and the cross-sectional view of FIG. 8 discloses a structure in which the second lead-out portion 22 disposed on the insulating substrate 13 is exposed to the second surface 102 of the body to be connected to the second external electrode 32.

### Third Embodiment

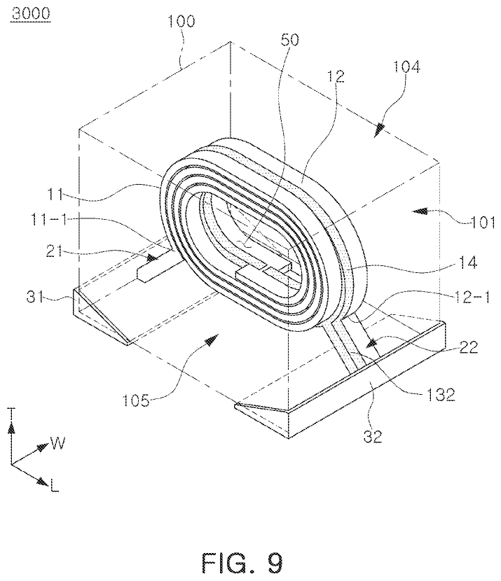

FIG. 9 is a perspective view of a coil component according to a third embodiment of the present disclosure.

Referring to FIG. 9, when compared with the coil components 1000 and 2000 according to the first and second embodiments of the present disclosure, a coil component 3000 according to a third embodiment has a different shape and exposure position. Therefore, in describing the present embodiment, only the shape and exposure position of the lead-out portion 20, different from those of the first and second embodiments will be described. For the remainder of the configuration of this embodiment, the descriptions in the first and second embodiments of the present disclosure may be applied as they are.

In the coil component 3000 according to a third embodiment of FIG. 9, a direction in which each of the first and second lead-out portions 21 and 22 extends and an angle formed by the third surface 103 of the body may change. Hereinafter, a direction in which the first and second lead-out portions 21 and 22 extend are referred to as X1 and X2 directions for easy description.

Specifically, in the case of the coil component 1000 according to the first embodiment currently disclosed in FIG. 3, each of the X1 and X2 directions is perpendicular to the third surface 103 of the body, and in the case of the coil component 2000 according to the second embodiment disclosed in FIG. 7, each of the X1 and X2 directions in which the lead-out portion 20 extends may be parallel to the third surface 103 of the body.

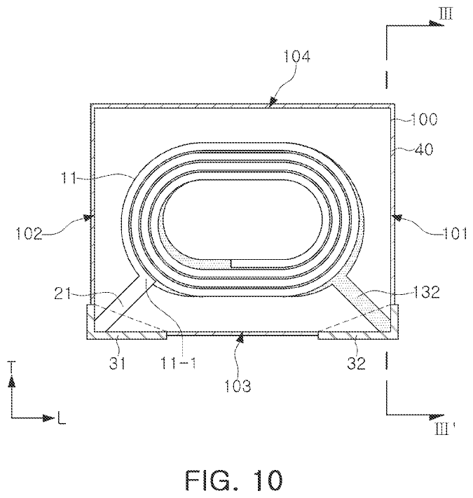

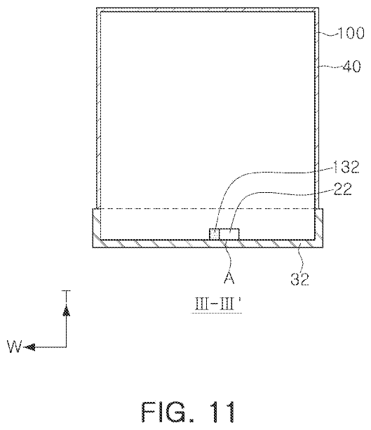

FIG. 10 is a transmittance view of the coil component of FIG. 9 in the width direction, and FIG. 11 is a cross-sectional view of the coil component of FIG. 10 taken along III-III′.

In the case of the coil component 3000 according to the third embodiment, when described based on an exposed region A in which the lead-out portion 20, led to each of the X1 and X2 directions is exposed to an external surface of the body 100, the exposed region A may be disposed at an arbitrary position between positions at which the exposed region A in each of the first embodiment 1000 of FIG. 3 and the second embodiment 2000 of FIG. 6 is currently disposed.

In other words, based on an acute angle of each of the X1 and X2 directions and the angle formed with the plane in which the third surface 103 of the body extends, in the first embodiment 1000, an angle formed by the X direction with the third surface 103 is 90°, and in the second embodiment 2000, an angle formed by the X direction by the third surface 103 is 0° (parallel), and in the third embodiment 3000, the angle formed by the X direction with the third surface 103 may have a value of 0° to 90°.

According to the third embodiment, the first lead-out portion 21 may be exposed to at least a portion of the third surface 103 and at least a portion of the second surface 102, and the second lead-out portion 22 may be exposed to at least a portion of the third surface 103 and at least a portion of the first surface 101.

According to the first to third embodiments of the present disclosure, the first and second external electrodes 31 and 32, each having an ‘L’ shape, may be connected to the first and second lead-out portions 21 and 22, respectively, and may be respectively disposed on edge portions of the third surface 103, which are opposing each other in the length direction L. A winding axis of the coil portion 10 may be substantially parallel to the third surface 103 of the body 100, and each of the first and second external electrodes 31 and 32 may further extend onto the fifth and sixth surfaces 105 and 106 of the body 100, opposing each other in the width direction

W which is substantially parallel to the winding axis of the coil portion 10 and substantially perpendicular to the length direction L.

According to one embodiment of the present disclosure, a distance (e.g., L1 in FIG. 4) between the first and second end portions 11-1 and 12-1 of the coil pattern 10 in the length direction L may be less than a maximum dimension (e.g., Lmax in FIG. 4) of the coil portion 10 in the length direction L.

The present disclosure is not limited by the above-described embodiments and the accompanying drawings, but is intended to be limited by the appended claims.

As set forth above, according to a coil component of an embodiment of the present disclosure, connection reliability between the lead-out portion and the coil portion may be improved.

In addition, according to a coil component according to another embodiment of the present disclosure, inductance of the component may be increased by increasing the number of turns of the coil pattern of the coil portion.

In addition, according to a coil component according to another embodiment of the present disclosure, it is possible to increase a surface area of the external electrode to improve adhesive strength of the coil component.

While this disclosure includes specific examples, it will be apparent to one of ordinary skill in the art that various changes in form and details may be made in these examples without departing from the spirit and scope of the claims and their equivalents.

What is claimed is:

1. A coil component, comprising:
a body having first and second surfaces facing each other in a length direction, third and fourth surfaces connecting the first and second surfaces and facing each other in a thickness direction, and fifth and sixth surfaces connecting the first to fourth surfaces and facing each other in a width direction;
an insulating substrate disposed inside the body;
a coil portion disposed on at least one surface of the insulating substrate, and including a coil pattern and a lead-out portion connected to an end portion of the coil pattern, the lead-out portion including one surface exposed externally of the body; and
first and second external electrodes covering the lead-out portion exposed externally of the body,
wherein the first external electrode is disposed on at least a portion of each of the first, third, fifth and sixth surfaces, and
the second external electrode is disposed on at least a portion of each of the second, third, fifth, and sixth surfaces.

2. The coil component of claim 1, wherein a height of a region of the first and second external electrodes, disposed on the fifth and sixth surfaces, decreases toward a central portion of the body in the length direction.

3. The coil component of claim 2, wherein the first and second external electrodes are disposed on the third surface of the body and separated from each other.

4. The coil component of claim 3, wherein a length of each of the first and second external electrodes in the length direction is 30% of a length of the body in the length direction or less.

5. The coil component of claim 4, wherein a height of each of the first and second external electrodes in the thickness direction is 10% of a thickness of the body in the thickness direction or less.

6. The coil component of claim 3, wherein the coil portion comprises:
first and second coil patterns disposed on a first surface and a second surface of the insulating substrate, respectively;
a first lead-out portion disposed on the first surface of the insulating substrate and connected to an end portion of the first coil pattern, wherein one surface of the first lead-out portion exposed externally of the body;
a second lead-out portion disposed on the second surface of the insulating substrate and connected to an end portion of the second coil pattern, wherein one surface of the second lead-out portion exposed to externally of the body; and
a via penetrating through the insulating substrate and connecting the first and second coil patterns to each other.

7. The coil component of claim 6, wherein the end portion of each of the first and second coil patterns is disposed below a central portion of the body in the thickness direction.

8. The coil component of claim 7, wherein the first and second lead-out portions are exposed to the third surface of the body.

9. The coil component of claim 7, wherein the first lead-out portion is exposed to the first surface of the body, and the second lead-out portion is exposed to the second surface of the body.

10. The coil component of claim 7, wherein the insulating substrate comprises a support portion supporting the first and second coil patterns, a first end portion supporting the first lead-out portion, and a second end portion supporting the second lead-out portion.

11. The coil component of claim 10, wherein each of the first and second external electrodes comprises a first layer covering each of the first and second lead-out portions, and a second layer covering the first layer.

12. The coil component of claim 11, wherein the first layer comprises a silver (Ag) layer, and the second layer comprises at least one of nickel (Ni) and tin (Sn).

13. A coil component, comprising:
a body;
an insulating substrate disposed inside the body;
a coil portion disposed on at least one surface of the insulating substrate, and including first and second coil patterns and first and second lead-out portions connected to end portions of the first and second coil patterns, respectively, and exposed externally of the body; and
first and second external electrodes, separated from each other, respectively covering the first and second lead-out portions,
wherein the first external electrode is disposed on at least a portion of a first surface among external surfaces of the body, to which the first lead-out portion is exposed, and further disposed on at least a portion of each of three surfaces respectively connected to the first surface, and
the second external electrode is disposed on at least a portion of a second surface among external surfaces of the body, to which the second lead-out portion is exposed, and further disposed on at least a portion of each of three surfaces respectively connected to the second surface.

14. The coil component of claim 13, wherein the first and second surfaces, to which the first and second lead-out portions are respectively exposed to, are an identical external surface of the body.

15. The coil component of claim 13, wherein the first and second surfaces, to which the first and second lead-out portions are respectively exposed to, are different external surfaces of the body from each other.

16. The coil component of claim 13, wherein a height of the first and second external electrodes decreases toward a central portion of the body in a length direction.

17. The coil component of claim 16, wherein the end portion of each of the first and second coil patterns is disposed below a central portion of the body in a thickness direction.

18. The coil component of claim 17, wherein each of the first and second lead-out portions is exposed to at least a portion of a lower surface or a side surface of the body.

19. The coil component of claim 17, wherein the first lead-out portion is exposed to at least a portion of a lower surface and at least a portion of a first side surface of the body, and
the second lead-out portion is exposed to at least a portion of the lower surface and at least a portion of a second side surface of the body opposing the first side surface.

20. A coil component, comprising:
a body;
an insulating substrate disposed inside the body;
a coil portion disposed on at least one surface of the insulating substrate, and including a coil pattern and first and second lead-out portions connected to first and second end portions of the coil pattern, respectively, and exposed externally of the body; and
first and second external electrodes, each having an ‘L’ shape, connected to the first and second lead-out portions, respectively,
wherein the first and second external electrodes are respectively disposed on edge portions of a lower surface of the body, which are opposing each other in a length direction,
a winding axis of the coil portion is substantially parallel to the lower surface of the body, and
each of the first and second external electrodes further extends onto front and rear surfaces of the body, opposing each other in a width direction which is substantially parallel to the winding axis of the coil portion and substantially perpendicular to the length direction.

21. The coil component of claim 20, wherein a height of the first and second external electrodes decreases toward a central portion of the body in the length direction.

22. The coil component of claim 20, wherein each of the first and second end portions of the coil pattern is disposed below a central portion of the body in a thickness direction which is orthogonal to the length and width directions.

23. The coil component of claim 22, wherein a distance between the first and second end portions of the coil pattern in the length direction is less than a maximum dimension of the coil portion in the length direction.

24. The coil component of claim 20, wherein each of the first and second lead-out portions is exposed to the lower surface of the body.

25. The coil component of claim 20, wherein the first and second lead-out portions are respectively exposed to first and second side surfaces of the body that are opposing each other in the length direction.

26. The coil component of claim 25, wherein the first and second lead-out portions extend downwardly towards the lower surface of the body, and are bent to extend laterally towards the first and second side surfaces of the body, respectively.

27. The coil component of claim 20, wherein the first lead-out portion is exposed to at least a portion of the lower surface and at least a portion of the first side surface of the body, and
the second lead-out portion is exposed to at least a portion of the lower surface and at least a portion of the second side surface of the body.

28. The coil component of claim 27, wherein the first and second lead-out portions respectively extend in first and second inclined directions angled from the lower surface of the body, where each angle formed between the first and second inclined directions and the lower surface is more than 0° and less than 90°.
